(19) United States
(12) Patent Application Publication
(10) Pub. No.: US 2024/0343546 A1
(43) Pub. Date: Oct. 17, 2024

(54) Fluid Modifying and Dispensing System

(71) Applicant: Struktur Inc., Thousand Oaks, CA (US)

(72) Inventor: Peter Falt, Thousand Oaks, CA (US)

(21) Appl. No.: 18/300,003

(22) Filed: Apr. 13, 2023

(51) Int. Cl. B67D 1/00; B01F 23/236; B01F 23/237; B01F 33/841; B65D 43/02; B65D 51/16; B67D 1/08; C02F 1/00; C02F 9/20

(52) U.S. Cl. CPC B67D 1/0042; B01F 23/2363; B01F 23/237621; B01F 23/23764; B01F 23/23765; B01F 33/841; B65D 43/0202; B65D 51/1644; B67D 1/0014; B67D 1/0052; B67D 1/0058; B67D 1/0888; B67D 1/0894; C02F 1/008; C02F 9/20; B01F 2101/48; B67D 1/0895; B67D 2210/0001; B67D 2210/00118; C02F 1/003; C02F 1/66; C02F 1/685; C02F 2307/06; C02F 2307/10; E03C 2201/40; E03C 2201/45

(57) ABSTRACT

Implementations of fluid modifying and dispensing systems may include a fluid modifying assembly having a fluid modification unit including a gas dosing unit configured to infuse a fluid with a gas, a filter configured to filter the fluid, and a pH regulator configured to modify a pH of the fluid. The fluid modifying assembly may include a temperature regulation system coupled to the fluid modification unit. The fluid modifying assembly may also include a dosing system coupled to the fluid modification unit. The dosing system may be configured to add one or more supplements to the fluid. The fluid modifying and dispensing system may include a fluid dispensing assembly having a faucet coupled to the fluid modifying assembly and a vessel having a lid and a base. The base of the vessel may be configured to couple directly to the faucet to fill the vessel with the fluid.

### BACKGROUND

### 1. Technical Field

Aspects of this document relate generally to fluid dispensers that dispense fluids for consumption. More specific implementations involve fluid modifying systems that modify fluids to be dispensed by the fluid dispenser.

### 2. Background

Fluid dispensers are used to dispense fluids for human consumption. These fluids commonly include water, juice, or soda. When dispensing juice or soda, water may be infused with concentrate just prior to being dispensed in order to dispense the resulting juice or soda.

### SUMMARY

Implementations of fluid modifying and dispensing systems may include a fluid modifying assembly having a fluid modification unit including a gas dosing unit configured to infuse a fluid with a gas, a filter configured to filter the fluid, and a pH regulator configured to modify a pH of the fluid. The fluid modifying assembly may include a temperature regulation system coupled to the fluid modification unit. The temperature regulation system may be configured to modify a temperature of the fluid. The fluid modifying assembly may also include a dosing system coupled to the fluid modification unit. The dosing system may be configured to add one or more supplements to the fluid. The fluid modifying and dispensing system may include a fluid dispensing assembly having a faucet coupled to the fluid modifying assembly and a vessel having a lid and a base. The base of the vessel may be configured to couple directly to the faucet to fill the vessel with the fluid.

Implementations of fluid modifying and dispensing systems may include one, all, or any of the following:

The fluid modifying assembly may be configured to be placed under a sink.

The gas dosing unit may be configured to either infuse CO2, nitrogen or hydrogen into the fluid.

The dosing system may include an in-line mixer configured to mix the one or more supplements within the fluid.

The dosing system may include a dosing reservoir having a plurality of compartments. Each compartment may be configured to store a different supplement. The dosing system may also include a plurality of rotating dosers. Each rotating doser may be configured to dispense a supplement of a compartment of the plurality of compartments.

Implementations of fluid modifying and dispensing systems may include a fluid modifying assembly and a fluid dispensing assembly coupled to the fluid modifying assembly. The fluid dispensing assembly may include a faucet coupled to the fluid modifying assembly and a vessel having a lid and a base. The base of the vessel may be configured to couple directly to the faucet to fill the vessel with the fluid through the base of the vessel.

Implementations of fluid modifying and dispensing systems may include one, all, or any of the following:

The faucet may include a retractable injector configured to fill the vessel when in a deployed position.

The faucet may include one or more locking mechanisms configured to secure the vessel to the faucet.

The faucet may be activated when the base of the vessel is coupled directly to the faucet.

The vessel may include an RFID tag. The fluid modifying and dispensing system may be configured to recognize the RFID tag before filling the vessel with the fluid.

The lid of the vessel may include a float valve configured to allow air to escape when filling the vessel with the fluid and to prevent the vessel from being overfilled by closing when the fluid engages the float valve.

The lid may include a pressure relief valve configured to be activated by a lever. The lever may also be configured to lock and unlock the lid to a remainder of the vessel.

The lid may include a safety pressure management valve configured to open and release pressure when an internal vessel pressure exceeds 80 psi.

Implementations of fluid modifying assemblies may include a fluid modification unit including a gas dosing unit configured to infuse a fluid with a gas, a filter configured to filter the fluid, and a pH regulator configured to modify a pH of the fluid. The fluid modifying assembly may include a temperature regulation system coupled to the fluid modification unit. The temperature regulation system may be configured to modify a temperature of the fluid. The fluid modifying assembly may also include a dosing system coupled to the fluid modification unit. The dosing system may include a dosing reservoir configured to store one or more supplements, a dosing unit configured to add one or more supplements to the fluid, and an inline mixer configured to mix the one or more supplements with the fluid.

Implementations of fluid modifying assemblies may include one, all, or any of the following:

The dosing reservoir may be removably coupled to the dosing unit.

The inline mixer may be housed within a dosing receiver. The dosing receiver may be configured to directly couple to and within the fluid modification unit.

The dosing unit may include two or more dosers.

The dosing reservoir may include a plurality of compartments.

The two or more dosers may be each rotatable.

The temperature regulation system may be directly coupled to the fluid modification unit.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a perspective view of a fluid modifying and dispensing system;

FIG. 2 is an exploded view of the fluid modifying and dispensing system of FIG. 1;

FIG. 3 is a perspective view of the fluid modifying and dispensing system of FIG. 1 installed next to a sink;

FIG. 4 is a view of a portion of the fluid dispensing assembly installed next to a sink;

FIG. 5 is an exploded view of a fluid modification unit and temperature regulation system;

FIG. 6 is a perspective and partially exploded view of a gas dosing unit;

FIG. 7 is a partially exploded view of a dosing system;

FIG. 8 is an exploded view of a dosing reservoir;

FIG. 9 is an exploded and magnified view of a dosing unit;

FIG. 10 is an exploded view of a doser;

FIG. 11 is a perspective view of a dosing receiver;

FIG. 12 is an exploded view of the dosing receiver of FIG. 11;

FIG. 13 is an exploded view of an inline mixer;

FIG. 14 is a side view of a faucet;

FIG. 15 is an exploded view of a faucet;

FIG. 16 is a perspective view of a vessel;

FIG. 17 is an exploded view of the vessel of FIG. 16;

FIG. 18 is an exploded view of the base of the vessel of FIG. 16; and

FIG. 19 is an exploded view of the lid of the vessel of FIG. 16.

### DESCRIPTION

This disclosure, its aspects and implementations, are not limited to the specific components, assembly procedures or method elements disclosed herein. Many additional components, assembly procedures and/or method elements known in the art consistent with the intended fluid modifying and dispensing system will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such fluid modifying and dispensing systems, and implementing components and methods, consistent with the intended operation and methods.

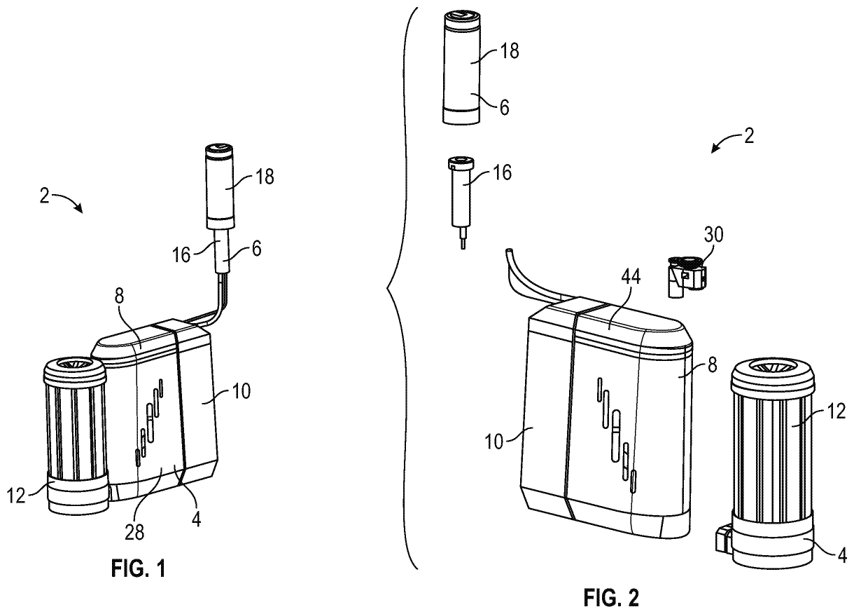

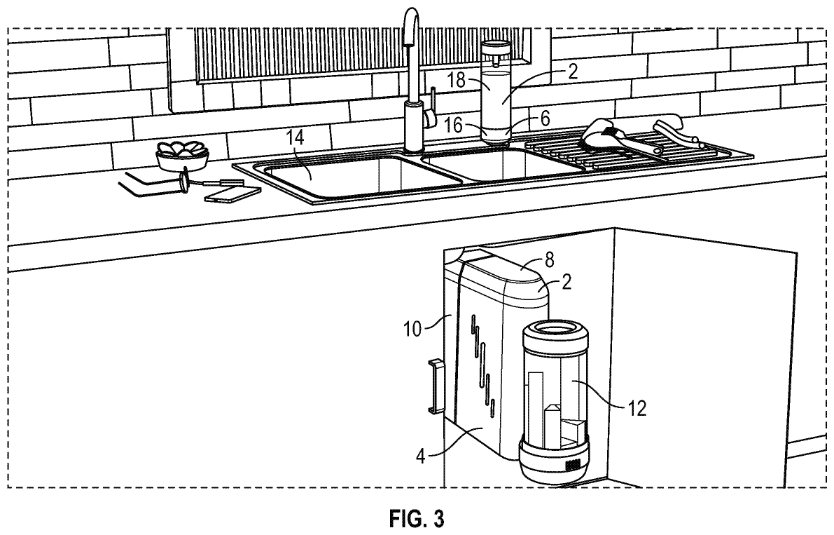

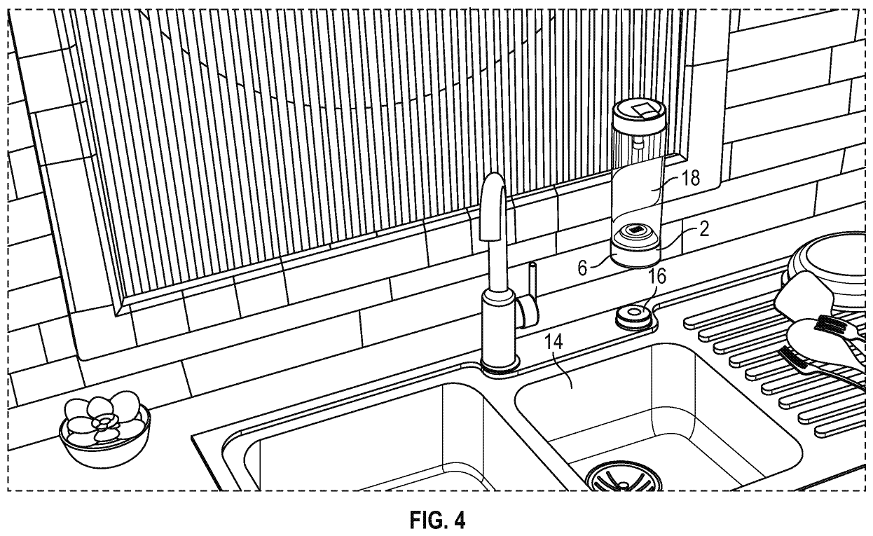

Referring to FIGS. 1-3, a fluid modifying and dispensing system 2 is illustrated. The fluid modifying and dispensing system 2 may be configured to modify and dispense water or other fluids. Referring specifically to FIG. 1, a perspective view of a fluid modifying and dispensing system is illustrated. Referring specifically to FIG. 2, an exploded view of the fluid modifying and dispensing system of FIG. 1 is illustrated. Referring specifically to FIG. 3, a perspective view of the fluid modifying and dispensing system of FIG. 1 installed next to a sink is illustrated. The fluid modifying and dispensing system 2 includes a fluid modifying assembly 4 and a fluid dispensing assembly 6. While the implementations of the fluid modifying and dispensing system 2 disclosed herein include both a fluid modifying assembly 4 and a fluid dispensing assembly 6, it is understood that the fluid modifying assembly may exist and operate separately and alone from the fluid dispensing assembly. Likewise, it is understood that the fluid dispensing assembly may exist and operate separately and alone from the fluid modifying assembly.

The fluid modifying assembly 4 may include a fluid modification unit 8, a temperature regulation system 10, and a dosing system 12. While the implementations disclosed herein discuss the fluid modifying assembly 4 as having all three of these elements, other implementations of fluid modifying assemblies may include just one or two of these elements. Similarly, the fluid modifying assembly 4 may be configured to operate with just one or two of these elements and may also be configured to have the other elements added to the fluid modifying assembly and then operate with these additional elements. In various implementations, and as illustrated by FIG. 3, the fluid modifying assembly 4 may be installed under a sink 14. In other implementations the fluid modifying assembly 4 may be installed in other portions of a structure or may not be installed within a structure separate from the fluid modifying and dispensing system 2.

The fluid modifying assembly 4 may be coupled to a fluid dispensing assembly 6. In various implementations, the fluid dispensing assembly 6 may include a faucet 16. The fluid dispensing assembly 6 may also include a vessel 18. While the implementations of fluid dispensing assemblies 6 disclosed herein include both a faucet 16 and a vessel 18, other implementations of fluid dispensing assemblies may include a faucet without a vessel.

Referring to FIG. 4, a view of a portion of the fluid dispensing assembly 6 installed next to a sink 14 is illustrated. As illustrated by FIGS. 3-4, the faucet 16 may be configured to extend through a counter or sink 14 to allow a user to fill the vessel 18 above the counter or sink while the fluid is modified below the sink. In other implementations the faucet 16 may be installed in a counter or sink differently or may be installed in other structures. In still other implementations, the faucet 16 may not be installed within a structure separate from the fluid modifying and dispensing system 2.

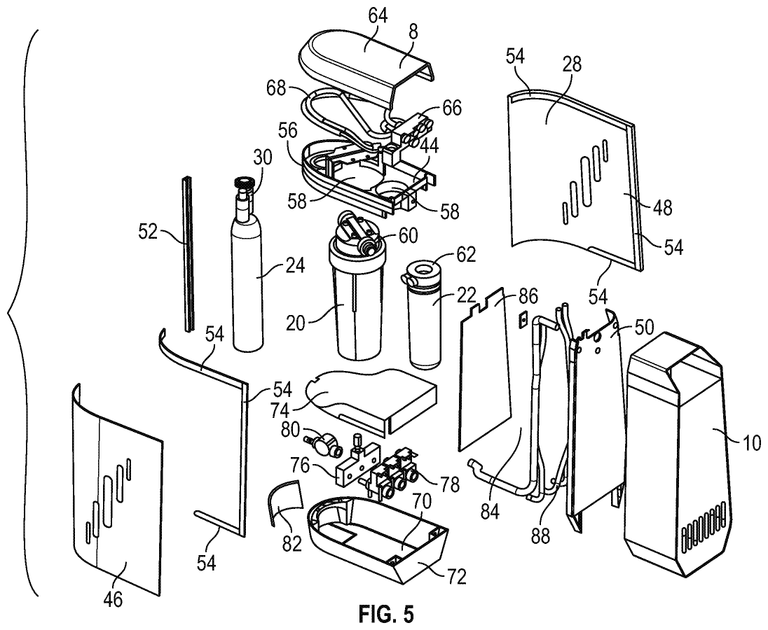

Referring to FIG. 5, an exploded view of a fluid modification unit 8 and temperature regulation system is illustrated. In various implementations, the fluid modification unit 8 may include a filter 20 configured to filter fluid passing through the filter.

The fluid modification unit 8 may include a pH regulator 22. The pH regulator 22 may be configured to adjust the pH of the fluid by infusing acid or a base into the fluid. In various implementations, the pH regulator may also be configured to measure the pH of the fluid in order to determine how much acid or base should be infused into the fluid in order to bring the pH to the predetermined value.

The fluid modification unit 8 may include a gas canister 24. The gas canister 24. The gas canister 24 may hold carbon dioxide, nitrogen, hydrogen, or any other gas that can be infused into a fluid to be consumed.

While FIG. 5 illustrates the fluid modification unit 8 as having all three of a filter 20, a pH regulator 22, and a gas canister 24, in other implementations the fluid modification unit may only include one or two of these elements. Similarly, the fluid modification unit may also be configured to operate with just one or two of these elements and also be configured to have additional elements added and then operate with the additional elements.

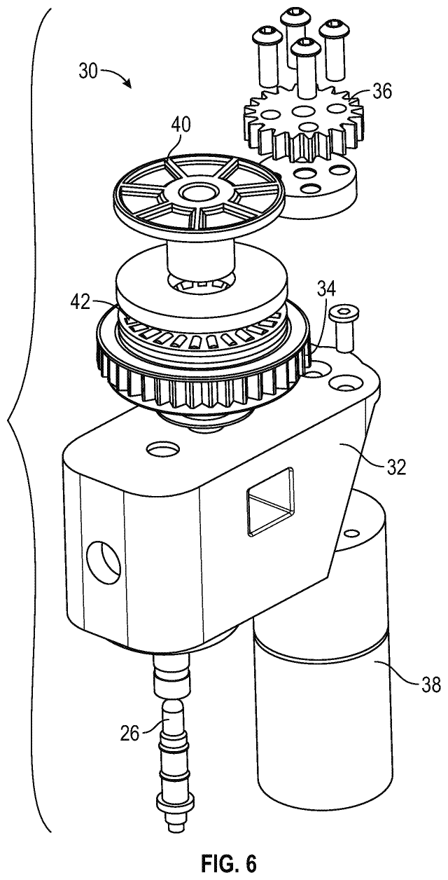

In implementations including a gas canister 24, the fluid modifying assembly 4 includes a gas dosing unit 30. As illustrated by FIG. 5, the gas dosing unit may be configured to attach to the head of the gas canister 24. Referring back to FIG. 2, a gas dosing unit 30 is illustrated exploded from the fluid modification unit 8. Referring to FIG. 6, a perspective and partially exploded view of a gas dosing unit 30 is illustrated. The gas dosing unit 30 is configured to control the amount of gas from the gas canister 24 that runs through the faucet and into the vessel. In turn, the gas dosing unit 30 is configured to infuse fluid with the gas of the gas canister 24.

In various implementations, the gas dosing unit 30 includes a housing 32. The gas dosing unit 30 may also include a drive gear 34. The drive gear 34 may be engaged by a second drive gear 36. The second drive gear 36 is turned by the motor 38. In various implementations, the gas dosing unit 30 may also include a gear hub 40 and a thrust needle roller 42. In various implementations, the gas dosing unit 30 includes a needle 26 through which the gas passes. In particular implementations, the thrust needle roller 42 may be configured to control the amount of gas by opening and closing the needle 26. In other implementations the gas dosing unit 30 may include other mechanisms used to control the amount of gas that passes through the gas dosing unit and into the fluid.

Referring back to FIG. 5, the fluid modification unit 8 includes a housing 28. The housing 28 may include a plurality of compartments. In particular implementations, the housing 28 includes a first compartment configured to house the gas canister 24, the pH regulator 22, and the filter 20. The first compartment may be formed from a first side panel 46 and a second side panel 48. The side panels may directly coupled to a spine 50. In various implementations, the first panel 46 may directly coupled to the second panel 48 at ends of the panels opposite the ends directly coupled to the spine 50. In other implementations, an additional panel may separate the first side panel 46 and the second side panel 48 at the ends of the side panels opposite the spine 50. In various implementations, and as illustrated by FIG. 5, the first side panel 46 and the second side panel 48 may each be configured to directly couple to a support 52. In various implementations, a plurality of magnetic strips 54 may be directly coupled to the first side panel 46, the second side panel 48, or both the first side panel and the second side panel. In such implementations, the plurality of magnetic strips 54 may be used to secure the side panels to the remainder of the housing. In such implementations, the side panels may be easily removed to facilitate maintenance of components within the fluid modification unit or to easily allow replacement of components (including the gas canister 24, pH regulator 22, and filter 20) within the fluid modification unit. In other implementations, other mechanisms aside from magnets may be used to attach the first side panel and the second side panel to the remainder of the housing.

In various implementations the housing 28 may also include a second compartment 44. The second compartment 44 may include a wet tray 56. The wet tray 56 may form a barrier between the first compartment and the second compartment 44. The wet tray 56 may include a plurality of openings 58 configured to receive a head portion 60 of the filter 20, a head portion 62 of the pH regulator 22, and the gas dosing unit 30. The wet tray is configured to directly couple with the spine 50 and to a cover 64 for the second compartment 44. In various implementations, the second compartment may include a first manifold 66 and a plurality of lines 68 through which fluid or gas may flow.

In various implementations, the housing 28 may include a third compartment 70. The third compartment 70 may include a base shell 72 configured to couple to a plate 74. The plate 74 may form a barrier between the first compartment and the third compartment 70. The third compartment 70 may include a second manifold 76, a plurality of solenoid valves 78, a flowmeter 80, and any combination thereof. In various implementations, the third compartment 70 may also include a removable dosing system panel 82. With the dosing system panel 82 removed, the dosing receiver may be configured to be inserted into the third compartment 70 and may be integrated into the fluid modifying assembly 4. The third compartment 70 may also be able to house a plurality of fluid lines.

In various implementations, the housing may include a fourth compartment 84 formed by the spine 50, the first side panel 46, the second side panel 48, and the divider plate 86. In such implementations, the fourth compartment 84 may house the plurality of fluid lines 88 extending between the second compartment 44 and the third compartment 70. In other implementations, the housing may not include a fourth compartment and the plurality of fluid lines 88 may run through the first compartment.

Similarly, while FIG. 5 illustrates the formation of four separate compartments within the fluid modification unit 8, in other implementations the fluid modification unit 8 may include only a single compartment, two compartments, three compartments, or more than four compartments. While the figures also illustrate the fluid modification unit 8 as having a closed housing, in other implementations the fluid modification unit may include an open housing through which the components of the fluid modification unit 8 may be accessible without having to remove a portion of the housing.

Fluid may be modified by the fluid modification unit 8 by first flowing into the outside of the first manifold 66. As an example, this fluid may be city water supplied to a home. The fluid may then come out from the inside of the first manifold 66 and then move into the filter 20. Filtered fluid then comes out of the filter 20. The path of fluid may split at this point into a first line and a second line. The first line may feed back into the manifold 66 and split into a third line, fourth line, and fifth line. The third line may connect to a chiller unit of the temperature regulation system 10. The fourth line may connect to a heater unit of the temperature regulation system 10. The fifth line may run from the first manifold 66 down to a fourth solenoid valve of a plurality of solenoid valves 78. While the plurality of solenoid valves 78 is illustrated in FIG. 5 as including three valves, in various implementations, the plurality of solenoid valves may include four valves, two valves, or more than four valves. The chiller and heater units of the temperature regulation system 10 may each include a return line that feeds either the chilled or heated water back into the outside of the first manifold 66. A chilled line and a heated line may exit the first manifold 66 and each may connect to a solenoid valve of the plurality of solenoid valves 78. The second line that split off after exiting the filter may run into the pH regulator 22 where the fluid of the second line may be infused with an acid or a base. Upon exiting the pH regulator 22 the second line may flow down to a solenoid valve of the plurality of solenoid valves 78.

Each solenoid valve of the plurality of solenoid valves 78 may be opened or closed to customize the temperature of and whether or not the dispensed fluid is pH regulated. The output of the plurality of solenoid valves 78 may flow into the second manifold 76 where all lines may be combined into a single exit line. The single exit line may then feed into a flowmeter 80. Output from the flowmeter 80 may then go into the inline mixer.

While a particular path of fluid being modified by the fluid modification unit 8 is described, in other implementations the path of fluid through the fluid modification unit, the number of lines, and the number of valves may differ. Further, in various implementations the fluid modification unit 8 may include additional valves to prevent fluid flow through various lines (for example, the unit may include a valve positioned before the pH regulator in the event that the pH regulator is removed, in which case the valve could be closed and the unit could still be operable).

Still referring to FIG. 5, in various implementations the fluid modifying assembly 4 may include a temperature regulation system 10. The temperature regulation system 10 may include a chilling unit and a heating unit configured to chill and heat fluid. The temperature regulation system 10 may include a chilled line that feeds into and exits from the chilling unit and a heating line that feeds into and exits from the heating unit. The chilled line and heating line are separate. In other implementations, the temperature regulation system 10 may include only a chilling unit and not a heating unit. In various implementations, the temperature regular system may include a thermometer configured to measure temperature the water prior to it reaching the chilling unit or the heating unit, the temperature of the water upon exiting the chilling unit or the heating unit, or both the temperature the water prior to and upon exiting the chilling minute and heating unit. Any of these measurements of temperature may be transmitted to the controller of the fluid modifying and dispensing system.

In various implementations, the temperature regulation system 10 may be directly coupled to the spine 50 of the fluid modification unit 8. In other implementations, the temperature regulation system may be located at different parts of the fluid modifying and dispensing system 2. In particular implementations, the temperature regulation system 10 may be included within the housing of the fluid modification unit 8.

In other implementations, the fluid modifying the dispensing system 2 may not include the temperature regulation system 10. In such implementations, the temperature of the fluid dispensed will be substantially the same as the temperature of the fluid that enters into the fluid modifying and dispensing system 2.

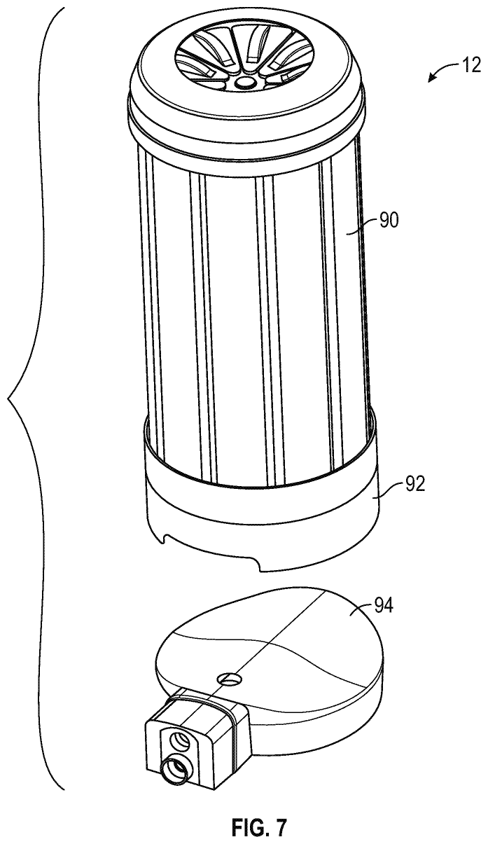

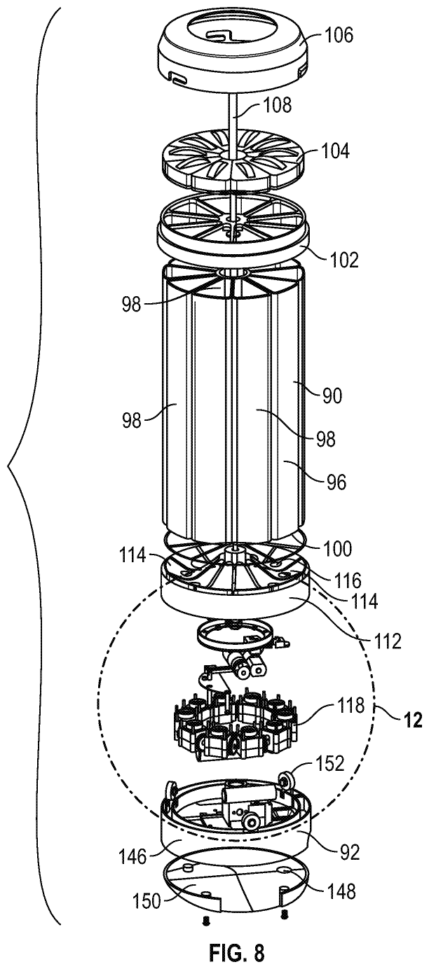

Referring to FIG. 7, a partially exploded view of a dosing system is illustrated. The dosing system 12 includes a dosing reservoir 90 coupled over a dosing unit 92. The dosing unit 92 may be coupled over a dosing receiver 94. Referring to FIG. 8, an exploded view of the dosing reservoir is illustrated. The dosing reservoir 90 includes a dosing bin 96. In various implementations, the dosing bin 96 includes a plurality of compartments 98. Each compartment is configured to hold supplements to be added to the fluid. As used herein, supplements may include vitamins, minerals, flavoring, or any other substance added to a fluid to be consumed. In particular implementations, the supplements may exist in a dry powdered form. In other implementations, the supplements may exist in a granulated form or a liquid form. Each compartment of the plurality of compartments 98 is configured to extend to the bottom 100 of the dosing bin 96. In such implementations, the dosing unit 92 may be gravity filled from the plurality of compartments 98. In various implementations, each compartment of the plurality of compartments 98 may be configured to hold a desiccant therein to ensure adequate dryness of dry supplements.

While the implementation illustrated by FIG. 8 discloses multiple compartments 98 within the dosing bin 96, in other implementations the dosing bin may include only a single compartment configured to hold a single type of supplement at a given time.

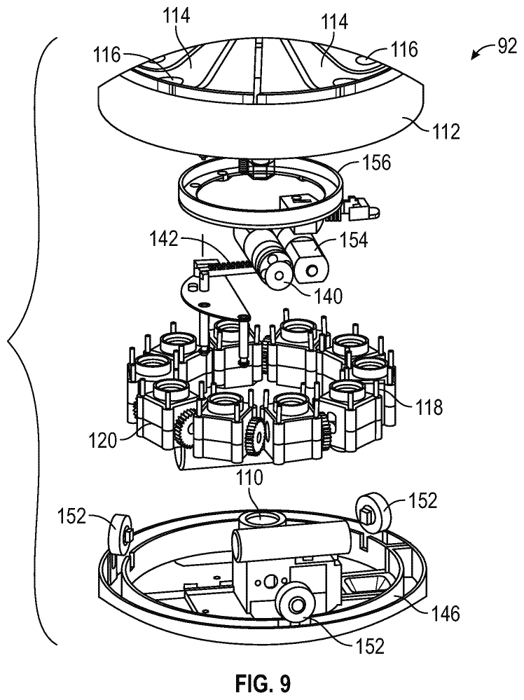

In various implementations, the dosing reservoir 90 includes a ring 102 configured to surround the plurality of compartments 98 and secure them to one another. The dosing reservoir 90 may also include caps 104 for each compartment within the dosing bin 96. In other implementations, the plurality of compartments may include a single lid covering all of the compartments. In various implementations, the dosing reservoir 90 may include a dosing reservoir lid 106 configured to at least partially cover the caps 104. The dosing reservoir lid 106 may be coupled to a central shaft 108 extending through the caps 104, the ring 102, the dosing bin 96, and into the shaft receiver 110 illustrated by FIG. 9. In various implementations, the central shaft 108 may center the various elements of the dosing reservoir 90.

Still referring to FIG. 8, the dosing reservoir 90 is directly coupled to a dosing unit 92. Referring to FIG. 9, an exploded and magnified view of the dosing unit of FIG. 8 is illustrated. In various implementations, the dosing unit 92 may include a turntable 112 directly coupled to the dosing bin 96. The turntable 112 may be divided into a plurality of sections 114 corresponding with the number of the plurality of compartments 98 of the dosing bin 96. Each section of the plurality of sections 114 may form a funnel with an opening 116 at the bottom of the funnel. The sections are all divided to ensure that supplements are not mixed with one another prior to reaching the fluid.

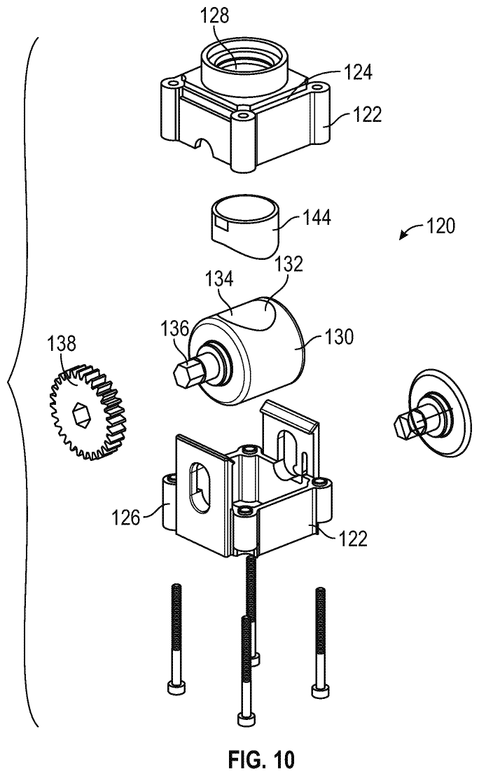

The dosing unit includes a plurality of dosers 118 coupled beneath the turntable 112. The number of dosers within the plurality of dosers 118 corresponds to the number of compartments 98 configured to hold supplements within the dosing bin 96. Referring to FIG. 10, an exploded view of a doser is illustrated. Each doser 120 includes a housing 122. The housing 122 may include a doser chute 124 and a doser base 126. In such implementations, the doser chute 124 includes an opening 128 aligned with the corresponding opening at the bottom of the funnel located directly above the doser. Similarly, the doser base 126 may include an opening in the bottom of the base aligned beneath the opening 128 of the doser chute 124. The doser chute 124 may be non-removably coupled to the doser base 126. In other implementations, the doser chute 124 may be removably coupled to the doser base 126.

Each doser 120 includes a doser drum 130. Each doser drum 130 includes an opening 132 to an internal volume 134 within the doser drum 130 configured to hold a particular amount of supplement. Each doser drum 130 may include a driveshaft 136 coupled to a gear 138. This gear 138 may be rotated (which in turn rotates the doser drum 130) by the dump motor 140 of FIG. 9. A dump gear may be mounted on the dump motor. The dump gear may engage with the gear bar 142. The gear bar 142 may be rotated and positioned to engage with any gear attached to the driveshaft of any doser drum. As the dump gear engages the gear bar 142, the gear bar 142 may engage the gear 138 of the doser 120 which may in turn rotate the doser drum 130. In such implementations, the doser drum 130 may be gravity filled with the supplement of the compartment positioned above the doser. The supplement may fall through the funnel, through the opening of in the doser chute, and into the internal volume 134 within the doser drum 130. The doser drum 130 dispenses the supplement by rotating the doser drum until the opening 132 of the internal volume 134 is aligned with and positioned immediately over the opening of the doser base 126, at which point the supplement may fall out of the internal volume 134 and through the opening of the doser base. The doser drum may then be rotated 180° back to a position to be filled again with supplement by reversing the motor.

In various implementations each doser 120 may include a scraper 144. The scraper 144 may scrape off excess supplement as the doser drum is rotated by the gear 138 attached to the driveshaft 136.

Referring back to FIGS. 8-9, in various implementations, the dosing unit 92 may include a drive base 146. The drive base includes an opening 148 through the bottom 150 of the drive base 146 through which dispensed supplement is configured to pass. The drive base 146 may include a plurality of rollers 152 to facilitate the rotation of the turntable 112 relative to the drive base 146 which may not be configured to rotate. The dosing unit 92 may include a turntable motor 154 mounted to the drive base 146. A motor mounted index gear may be directly coupled to the turntable motor 154 which may engage the drive ring 156. The drive ring 156 may be fixedly coupled to the turntable 112 and to the plurality of dosers 118. In turn, when the turntable motor 154 is activated, this may activate rotation of the drive ring 156 which may then impart rotation to the plurality of dosers 118, the turntable 112, and the dosing reservoir 90 positioned on the turntable. In such implementations, a controller of the fluid modifying and dispensing system 2 may transmit a signal which activates the turntable motor 154 and rotates a particular supplement over the opening 148 in the drive base 146. Supplement may fill the doser drum of the corresponding doser and the controller may send a signal that activates the motor 140 to rotate the doser drum and dispense the supplement through the opening 148 in the bottom 150 of the drive base 146. In implementations where additional amounts of the same type of supplement is desired, the controller may send a signal to activate the reverse rotation of the doser drum which may then be filled again and rotated back again to dispense additional supplement. This process may be repeated until the desired amount of that particular supplement has been dispensed. In implementations where other supplements are also desired to be dispensed, the controller may then send a result to activate the turntable motor 154 to align a different supplement over the opening 148 in the bottom 150 of the drive base 146 and then to dispense that different supplement using the corresponding doser. Any of the motors or all of the motors within the dosing unit 92 may be battery-powered. In such implementations, these batteries may be wirelessly charged by a wireless charge which may be included in the housing of the dosing receiver. In implementations where a motor within the dosing unit is not configured to rotate, that motor may be powered by and wired to the same power source that powers the remainder of the fluid modifying and dispensing system 2.

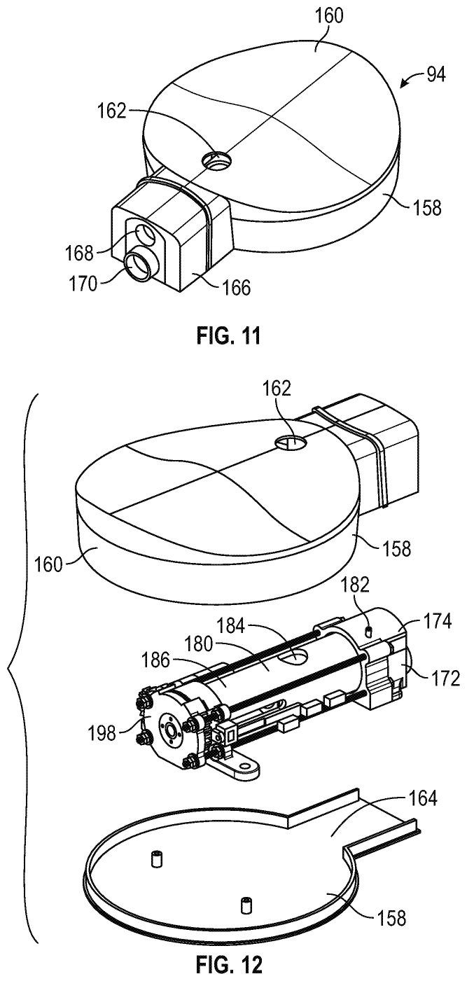

Referring to FIG. 11, a perspective view of a dosing receiver is illustrated. Referring to FIG. 12, an exploded view of the dosing receiver of FIG. 11 is illustrated. The dosing receiver 94 includes a housing 158. The housing 158 may include an upper portion 160. In such implementations, the upper portion 160 includes an opening 162 therethrough configured to receive the supplement dispensed by a doser. The opening 162 through the upper portion 160 of the housing 158 aligns with the opening 148 through the drive base 146 of the dosing unit 92. The housing 15 may also include a base 164 directly coupled to the upper portion 160.

The housing 158 may include a stem 166 configured to be received into the third compartment of the fluid modification unit. In such implementations, the modified fluid may enter into the dosing receiver 94 through the stem 166 in order to be infused with supplements dispensed by the plurality of dosers. As illustrated by FIG. 11, the stem includes an input opening 168 configured to receive fluid entering into the dosing receiver 94 and a return opening 170 configured to receive infused fluid exiting the dosing receiver.

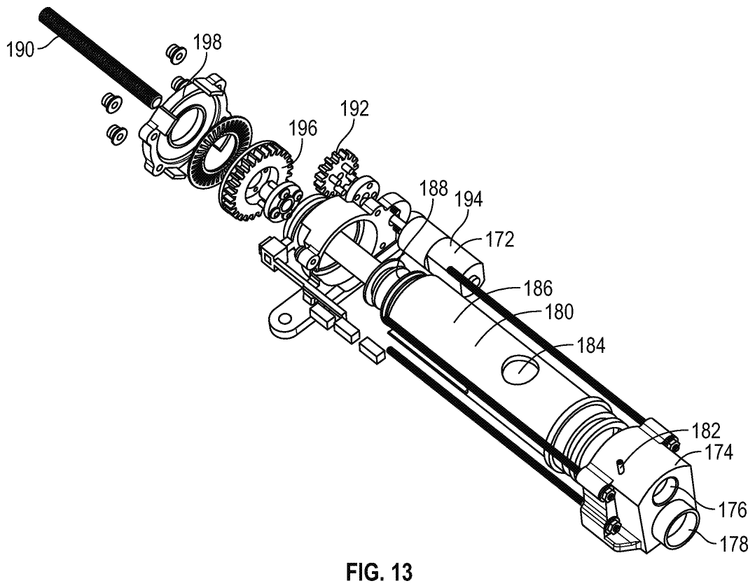

In various implementations, the dosing receiver 94 may include an in-line mixer 172. Referring to FIG. 13, an exploded view of the in-line mixer of FIG. 12 is illustrated. The in-line mixer 172 includes a head unit 174. The head unit 174 includes an inlet opening 176 and a return opening 178. The inlet opening 176 is configured to connect with a line extending from the input opening 168 of the stem 166 and the return opening 178 is configured to connect with a line extending from the return opening 170 of the stem 166. The head unit 174 is directly coupled to a main tube 180. In various implementations, the head unit 174 may be sealed and threaded onto the main tube 180. In other implementations, the head unit 174 may be sealed to the main tube 180 through a different attachment mechanism. As illustrated by FIG. 13, the head unit 174 may include a check valve 182. The check valve 182 may be configured to pull in air into the main tube 180 and create an air cavity inside the main tube. This air cavity may allow for the supplement material delivered from the doser to fill the main tube 180 without overflowing the opening 184 in the main tube 180.

The main tube 180 includes an opening 184 through a sidewall 186 of the main tube. The opening 184 is configured to receive supplement from the dosing unit 92. The opening 184 in the main tube 80 aligns with the opening 162 in the upper portion 160 of the housing 158 of the dosing receiver 94.

The in-line mixer 172 includes a plunger 188 configured to slide within the main tube 180. The plunger 188 may be attached to a threaded spindle 190. A gear 192 may be rotated by a motor 194, and this rotation of the gear 192 may be translated to rotation of the plunger gear 196. In such implementations, when the plunger gear 196 is rotated, the spindle 190 rotates and the plunger 188 is either pushed towards the head unit 174 or pulled away from the head unit 174.

The in-line mixer 172 may include a rear cap 198 configured to secure various mechanisms used to move the plunger 188 in the main tube 180.

To infuse fluid with a supplement, a controller of the fluid modifying and dispensing system may send a signal to activate movement of the plunger 188 and withdraw it beyond the opening 184 in the sidewall 186 of the main tube 180. The doser may then dispense supplement into the main tube 180 through the opening 184. Upon dumping the supplement, the controller may send another signal which may activate the plunger to move back past the opening 184 in order to seal the area of the main tube 180 having the supplement. A controller than may send a signal to activate a solenoid valve which allows for fluid to flow from the flowmeter 80 of the fluid modification unit 8, to the inlet opening 176, and into the main tube 180 where the fluid is then infused with the supplement. The infused fluid may then flow out of the in-line mixer 172 through the return opening 178 to be dispensed.

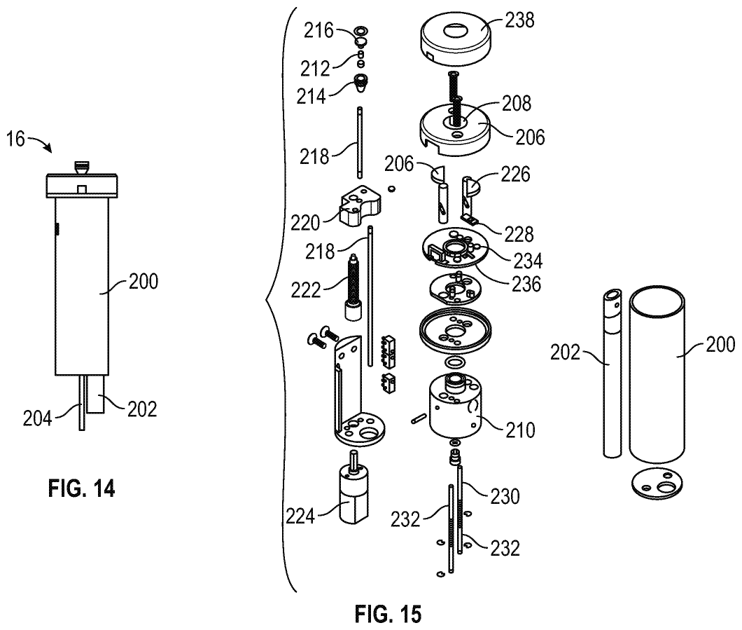

In various implementations, the fluid dispensing assembly 6 may include a faucet 16. Referring to FIG. 14, a side view of a faucet is illustrated. Referring to FIG. 15, an exploded view of the faucet of FIG. 14 is illustrated. The faucet 16 includes a main housing 200 configured to house the internal components of the faucet. The faucet 16 may also receive a fluid line 202 which is configured to transport the modified fluid in the fluid modifying assembly into the faucet. In various implementations, the faucet 16 may also receive a gas line 204 which is configured to transport gas from the gas canister into the faucet. In such implementations, the fluid entering into the faucet is not yet infused with the gas. In other implementations, the fluid may be infused with the gas prior to reaching the faucet and the gas line may not extend into the faucet.

In various implementations, the faucet 16 includes a top plate 206 coupled to the main housing 200. The top plate 206 may include an opening 208 therein through which a portion of the core 210 of the faucet 16 may extend. The core 210 of the faucet 16 may include an injector assembly that includes a check tube 212, an injector base 214, an injector cap 216, and the gas lines 218. The gas lines 218 may be coupled to a gas line configured to carry gas from the gas canister. In various implementations, the injector assembly may be moved up and down by the shuttle 220 along the shuttle lead screw 222. The shuttle lead screw 222 may be driven by the motor 224. In various implementations, when the injector assembly is lifted in a deployed position fluid and gas may be configured to flow into the vessel. When the injector assembly is in a retracted position, the flow of fluid and gas may be stopped.

In various implementations, the faucet 16 may include one or more doors 226 configured to open when a vessel is engaged on the faucet. A switch lever 228 coupled to the doors may be depressed by a bottom of the bottle which may activate a switch to open the doors 226, deploy the injector assembly, and fill the vessel with fluid and/or gas.

In various implementations, the faucet 16 may include a locking mechanism 230 which locks the vessel to the faucet until the vessel is filled. In particular implementations, the locking mechanisms may include one or more pins 232 configured to extend from the faucet 16 and lock the vessel to the faucet until the vessels filled or until the faucet receives a command from the controller to unlock the vessel.

In various implementations, the faucet may include a plurality of LED lights 234 mounted on a plate 236. The LED lights may communicate with a user through either colors of the LED lights, flashing patterns of the LED lights, or whether the LED lights are on or off. For example, the LED lights may be red until a vessel is locked to the faucet, at which point the LED lights may turn green indicating to the user that the vessel is ready to fill with fluid.

In various implementations, the faucet 16 may include a speaker. The speaker may also communicate to user. In various implementations, the faucet may include a microphone, the microphone may be configured to receive commands from a user which are then transmitted to a controller of the fluid modifying the dispensing system 2. The controller may then transmit appropriate signals to other elements of the fluid modifying and dispensing system in order to satisfy the requests of the user.

In various implementations, the faucet 16 may include a cover 238. The cover 238 may give the faucet a decorative and finished look and may also protect portions of the faucet below the cover.

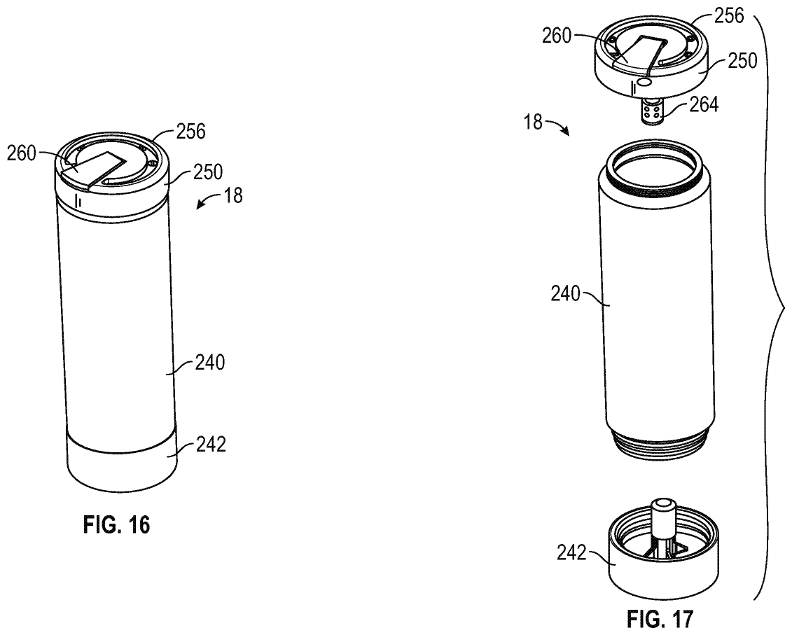

In various implementations, the fluid modifying assembly may include a vessel 18. Referring to FIG. 16, a perspective view of a vessel is illustrated. Referring to FIG. 17, an exploded view of the vessel of FIG. 16 is illustrated. The vessel includes a main body 240. In various implementations, the main body 240 may be insulated. The main body 240 may be made from polymers, glass, metal, any combination thereof, or any other material capable of holding a fluid. In various implementations, the main body 240 may be transparent. In other implementations, the main body 240 may be opaque.

The vessel 18 includes a base 242. In various implementations, the base 242 may be threaded onto the main body 240. In other implementations, the base 242 may be attached to the main body 240 through other attachment mechanisms. The base 242 may be removable in order to clean or repair components of the base.

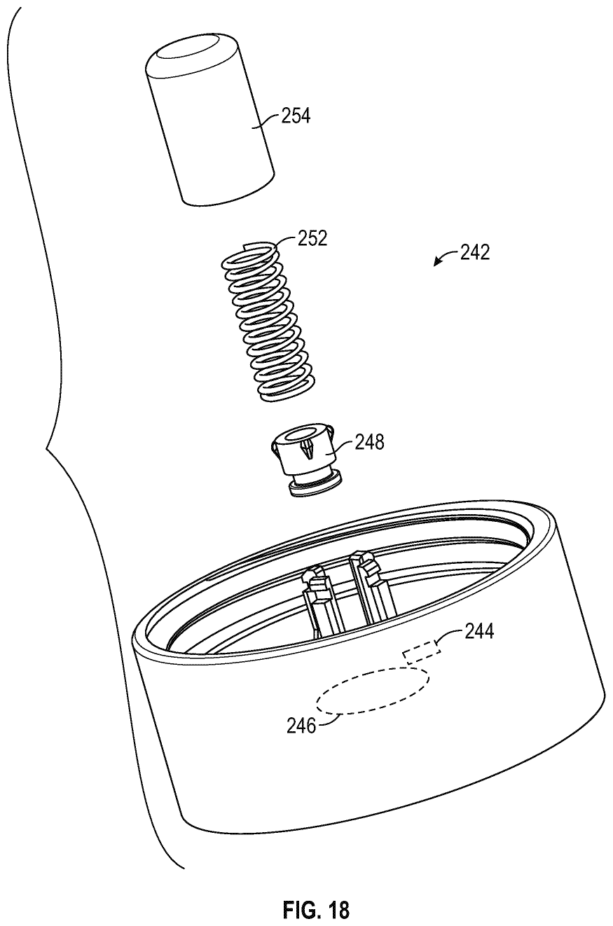

Referring to FIG. 18, an exploded view of the base of the vessel of FIG. 16 is illustrated. The base 242 may include an RFID integrated circuit 244. The base may also include an antenna ring 246. The RFID circuit and the antenna ring 246 may be configured to receive a signal from the faucet 16 and/or transmit a signal to the faucet. In various implementations the vessel 18 and faucet 16 may be required to be paired prior to the vessel being filled by the faucet. Further, in various implementations the fluid modifying and dispensing system 2 may include a memory (or may be configured to access a memory external to the fluid modifying dispensing system) that a stores data associated with a particular vessel. Such data may include, by nonlimiting example, types of supplements to be infused into the fluid, amounts of supplements to be used into the fluid, a particular pH of the fluid, desired temperature of the fluid, a gas infusion level of a fluid, or other parameters of the modified fluid. When the vessel 18 is paired with the faucet 16, the fluid modifying and dispensing system 2 may then modify the fluid in a manner specific to the particular vessel attached to and paired with the faucet.

In various implementations the base 242 includes an opening through which the injector assembly may be inserted. In such implementations, the base 242 may also include a poppet 248 configured to be pushed towards the lid 250 of the vessel 18. When the poppet is pushed towards a lid 250 of the vessel 18, the base 242 of the vessel may be opened and a allow for a fluid and/or gas to flow into the vessel from the faucet. The base 242 may include a spring 252 and a poppet cap 254. The poppet cap is fixed to the base and is configured to cover the spring 252. The spring 252 is configured to bias the poppet in a downwards position to ensure that the base is closed unless the poppet 248 is pushed into an open position by the injector assembly of the faucet 16. In other implementations, other opening mechanisms may be used in order to open the base 242 of the vessel 18 to be filled by the faucet 16.

In particular implementations, the vessel illustrated by the figures disclose the fluid and gas as entering the vessel through the base of the vessel. In other words, the vessel is filled from the bottom up. In other implementations, the vessel may be filled through the top of the vessel (or the end of the vessel directly coupled to the lid).

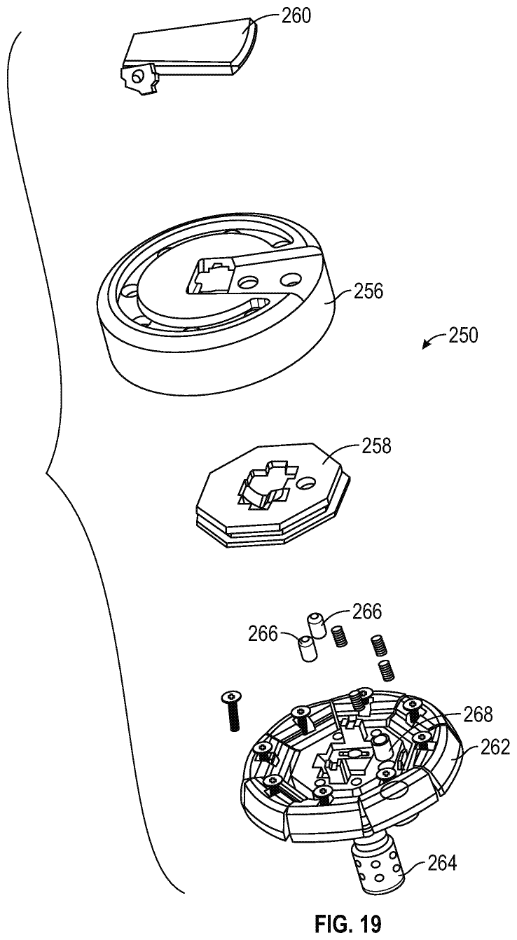

Referring to FIG. 19, an exploded view of the lid 250 of the vessel of FIG. 16 is illustrated. In various implementations, the lid 250 includes a lid top 256. A spring plate 258 may be coupled to the lid top and activated by the lever 260. Upon activation, the spring plate 258 may release the claws 262 from the main body 240 of vessel 18 and release the lid 250 from the vessel. Likewise, when the lever is moved in the opposite direction the claws 262, through the spring plate 258, attach to the main body 240 of the vessel 18 and lock the lid 250 to the main body 240.

In various implementations, the lid 250 includes a float valve 264. The float valve 264 may control the fluid fill level. As illustrated, the float valve 264 is attached to the surface of the lid 250 configured to face within the main body 240 of the vessel 18. The float valve may allow air to escape as the fluid is filling the vessel inasmuch as the float valve 264 will be in an open position when held upright. As the fluid reaches the float valve the fluid may push the buoyant valve closed against an o-ring and prevent the fluid from filling the bottle further. Upon the float valve being closed, the lid may send a signal to the controller or to the faucet 16 to stop filling the vessel.

In various implementations, the float valve may also prevent water from escaping when in an upside down orientation. In such implementations, the float valve may include two balls. One ball is buoyant and the other ball is heavier and non-buoyant. When in upside down configuration, the heavier ball may be on top of the buoyant ball and may push the buoyant ball downwards towards the lid 250 till the buoyant ball seats against an o-ring.

In various implementations, the lid 250 may include a safety pressure management system. The safety pressure management system may include dual pressure release valves 266 configured to release pressure when the lever 260 is lifted to a particular angle before activating the spring plate 258 and releasing the lid 250 from the vessel. In particular implementations, the lever is lifted to 22° to release pressure through the release valves prior to the lid 250 being unlocked from the vessel 18. In various implementations, the pressure release valves 266 may be closed when the lever is not activated, thereby maintaining levels of gas infused within the fluid and vessel. In various implementations, the safety pressure management system includes a blow off valve 268. The blow off valve 268 may release pressure in the vessel if the pressure exceeds a predetermined threshold within the vessel. In particular implementations, the blow off valve 268 may release pressure in the bottle when the pressure exceeds 80 psi. The blow off valve 268 may have a hysteresis of 20 psi, resealing the vessel at a lower pressure until the pressure release valves are activated by the lever 260 being lifted.

In other implementations, the lid 250 may include other valves that open and close in order to let air escape from vessel while filling the vessel and to also seal the vessel.

In various implementations, the lid 250 may be removed in order for a user to drink the fluid in the vessel. In other implementations, upon fully lifting the lever, an opening may be exposed into the main body of the vessel allowing a user to drink the fluid through the opening in the lid.

In other implementations of fluid dispensing assemblies, the fluid dispensing assembly may include other faucets which may be configured to fill other types of vessels. For example, other implementations of faucets may include a spout configured to dispense the fluid in a downwards direction towards a vessel placed under the faucet.

In various implementations, the fluid modifying and dispensing system 2 includes a controller configured to operate and control the different mechanisms used to modify and dispense the fluid. The fluid modifying and dispensing system may also be coupled to a server. In various implementations, the server may be a cloud-based server. The user may be able to communicate with the server in order to control how the controller modifies and dispenses the fluid. In various implementations, the user may be able to communicate with the server through a computer application, such as an application on a mobile phone.

The Controller may also be configured to send notifications to the server and those notifications may be forwarded to the user. In such implementations the fluid modifying and dispensing system may include sensors that monitor different elements of the system. For example, the fluid modifying and dispensing system may include a supplement sensor which monitors the levels of the various supplements in the dosing bin. When these levels reach a low level, the sensor may transmit a signal to the controller which may then relay the notification to the server. The server may then notify the user that their supplement levels are low and need to be refilled.

The implementations disclosed herein enable a user to uniquely modify fluid, such water, to accommodate unique needs and preferences of the user. For example, if one user is lacking in a particular mineral and/or vitamin, the user may be able to instruct the fluid modifying and dispensing system 2 to supplement the fluid with the particular mineral and/or vitamin. Similarly, if another user prefers their water to be carbonated and slightly chilled, that user may be able to instruct the system to carbonate and slightly chill their water.

While the implementation of the fluid modifying and dispensing system 2 discussed herein include numerous elements, it is understood that these elements may be added on to improve the functionality of the system. For example, a user may purchase a fluid modifying and dispensing system similar to the systems disclosed herein except without the dosing system. The system may still be configured to carbonate, filter, regulate the pH, heat, or chill the fluid, but may not be configured to supplement the fluid with supplements. The user may then purchase the dosing system separately and add it to the existing system, at which point the system may also be able to infuse the fluid with supplements.

In places where the description above refers to particular implementations of fluid modifying and dispensing systems and implementing components, sub-components, methods and sub-methods, it should be readily apparent that a number of modifications may be made without departing from the spirit thereof and that these implementations, implementing components, sub-components, methods and sub-methods may be applied to other fluid modifying and dispensing systems.

What is claimed is:

1. A fluid modifier and dispensing system comprising:
a fluid modifying assembly comprising:
a fluid modification unit comprising:
a gas dosing unit configured to infuse a fluid with a gas;
a filter configured to filter the fluid; and
a pH regulator configured to modify a pH of the fluid;
a temperature regulation system coupled to the fluid modification unit, wherein the temperature regulation system is configured to modify a temperature of the fluid; and
a dosing system coupled to the fluid modification unit, wherein the dosing system is configured to add one or more supplements to the fluid; and
a fluid dispensing assembly comprising:
a faucet coupled to the fluid modifying assembly; and
a vessel comprising a lid and a base;
wherein the base of the vessel is configured to couple directly to the faucet to fill the vessel with the fluid.

2. The system of claim 1, wherein the fluid modifying assembly is configured to be placed under a sink.

3. The system of claim 1, wherein the gas dosing unit is configured to one of infuse CO2, nitrogen or hydrogen into the fluid.

4. The system of claim 1, wherein the dosing system comprises an in-line mixer configured to mix the one or more supplements within the fluid.

5. The system of claim 1, wherein the dosing system comprises a dosing reservoir comprising a plurality of compartments, each compartment configured to store a different supplement, and also comprises a plurality of rotating dosers, each rotating doser configured to dispense a supplement of a compartment of the plurality of compartments.

6. A fluid modifying and dispensing system comprising:
a fluid modifying assembly; and
a fluid dispensing assembly coupled to the fluid modifying assembly, the fluid dispensing assembly comprising:
a faucet coupled to the fluid modifying assembly; and
a vessel comprising a lid and a base;
wherein the base of the vessel is configured to couple directly to the faucet to fill the vessel with the fluid through the base of the vessel.

7. The system of claim 6, wherein the faucet comprises a retractable injector configured to fill the vessel when in a deployed position.

8. The system of claim 6, wherein the faucet comprises one or more locking mechanisms configured to secure the vessel to the faucet.

9. The system of claim 6, wherein the faucet is activated when the base of the vessel is coupled directly to the faucet.

10. The system of claim 6, wherein the vessel comprises an RFID integrated circuit, wherein the fluid modifying and dispensing system is configured to recognize the RFID integrated circuit before filling the vessel with the fluid.

11. The system of claim 6, wherein the lid of the vessel comprises a float valve configured to allow air to escape when filling the vessel with the fluid and to prevent the vessel from being overfilled by closing when the fluid engages the float valve.

12. The system of claim 6, wherein the lid comprises a pressure relief valve configured to be activated by a lever, wherein the lever is also configured to lock and unlock the lid to a remainder of the vessel.

13. The system of claim 6, wherein the lid comprises a safety pressure management valve configured to open and release pressure when an internal vessel pressure exceeds 80 psi.

14. A fluid modifying assembly comprising:
a fluid modification unit comprising:
a gas dosing unit configured to infuse a fluid with a gas;
a filter configured to filter the fluid; and
a pH regulator configured to modify a pH of the fluid;
a temperature regulation system coupled to the fluid modification unit, wherein the temperature regulation system is configured to modify a temperature of the fluid; and
a dosing system coupled to the fluid modification unit, the dosing system comprising:
a dosing reservoir configured to store one or more supplements;
a dosing unit configured to add one or more supplements to the fluid; and
an inline mixer configured to mix the one or more supplements with the fluid.

15. The assembly of claim 14, wherein the dosing reservoir is removably coupled to the dosing unit.

16. The assembly of claim 14, wherein the inline mixer is housed within a dosing receiver, wherein the dosing receiver is configured to directly couple to and within the fluid modification unit.

17. The assembly of claim 14, wherein the dosing unit further includes two or more dosers.

18. The assembly of claim 14, wherein the dosing reservoir includes a plurality of compartments configured to hold a plurality of supplements.

19. The assembly of claim 17, wherein the two or more dosers are each rotatable.

20. The assembly of claim 14, wherein the temperature regulation system is directly coupled to the fluid modification unit.
